(19) United States
(12) Patent Application Publication
(10) Pub. No.: US 2018/0356228 A1
(43) Pub. Date: Dec. 13, 2018

(54) WAVELENGTH-CORRECTIVE LIGHT SOURCE APPARATUS AND METHOD

(71) Applicant: The Charles Stark Draper Laboratory, Inc., Cambridge, MA (US)

(72) Inventor: Gilbert D. Feke, Windham, NH (US)

(21) Appl. No.: 16/000,767

(22) Filed: Jun. 5, 2018

Related U.S. Application Data
(60) Provisional application No. 62/516,032, filed on Jun. 6, 2017.

(51) Int. Cl. G01C 19/72; H05B 37/02

(52) U.S. Cl. CPC G01C 19/721; H05B 37/0227

(57) ABSTRACT

A wavelength-corrective light source apparatus, and corresponding method, includes a light source emitting light characterized by a wavelength spectrum having a centroid wavelength with a centroid wavelength operational sensitivity. The apparatus also includes a wavelength-sensitive photodetector having a unitary active area characterized by a plurality of different responsivity spectra. The photodetector is configured to detect the light and deliver a plurality of different wavelength constituent photocurrent signals in response to the detected light corresponding to the different responsivity spectra. The apparatus further includes a centroid wavelength correction circuit configured to receive and act on the plurality of different wavelength constituent photocurrent signals to compensate for the centroid wavelength operational sensitivity. The photocurrent signals may have a nonlinearity with respect to the centroid wavelength, and nonlinearity cancellation can be provided. A nonlinearity corrected fiber-optic gyroscope may include the light source apparatus.

### RELATED APPLICATION

This application claims the benefit of U.S. Provisional Application No. 62/516,032, filed on Jun. 6, 2017. The entire teachings of the above application are incorporated herein by reference.

### FIELD

This disclosure relates generally to light sources and more particularly to a wavelength-corrective light source apparatus and method.

### BACKGROUND

Light sources used in sensor applications are well known in the art and include narrowband light sources such as lasers, laser diodes (LDs), and tunable laser diodes (TLDs), for providing narrowband light, as well as broadband light sources such as superluminescent diodes (SLDs), rare-earth-doped superluminescent sources (REDSLSs), and light emitting diodes (LEDs), for providing broadband light. Broadband light, for example light characterized by a spectrum having a full width at half maximum (FWHM) bandwidth of about 5 nm or greater, is useful in applications related to interferometry to avoid coherence noise effects. Many such sensor applications for light sources may benefit from wavelength correction, or equivalently frequency correction: for example compensation or calibration of the sensor to correct for fluctuations of the centroid, or average, wavelength of the light provided by the light source due to a wavelength operational sensitivity, for example wavelength thermal sensitivity that causes the centroid wavelength to fluctuate due to fluctuation of the temperature of the light source, or wavelength drive current sensitivity that causes the centroid wavelength to fluctuate due to fluctuation of the drive current applied to the light source; or active control, or stabilization, of the centroid wavelength of the light provided by the light source to counteract the wavelength operational sensitivity.

For example, fiber optic gyroscopes (FOGs) are sensors that use the interference of source light from a light source to measure angular velocity as known in the art. Rotation is sensed in a FOG with a large coil of optical fiber forming a Sagnac interferometer as described for example in H. C. Lefèvre, The Fiber Optic Gyroscope, 2nd Edition, Boston: Artech House (2014). The induced phase shift between the counterpropagating light waves injected in the sensor coil is proportional to the rotation rate and is measured by means of a photodetector known in the art as a rate photodetector. The proportionality constant, called “scale factor”, is given by 2πLD/λ̅c, where L is the length of the fiber coil, D is the diameter of the fiber coil, c is the speed of light in vacuum, and λ̅ is the average, or centroid, wavelength of the light waves propagating in the coil. The centroid wavelength is defined by equation 1:

$$\overline{λ} = \frac{\int λ P ( λ ) d λ}{\int P ( λ ) d λ}$$

where λ is the wavelength of the spectral components of the light waves, and P(λ) is the optical power as a function of λ, that is, the spectral distribution of the light waves. Hence the accuracy of the gyroscope is limited by the accuracy by which λ̅ of the light source is known. In particular, for FOGs to be useful in certain navigation applications, λ̅ must be accurate to 10 parts per million (ppm) or better over a range of temperature ΔT that can span up to 10° C. or more, that is

$$\frac{1}{\overline{λ}} \frac{Δ \overline{λ}}{Δ T} = \frac{1}{\overline{λ}} α < {10}^{- 6} \frac{1}{° C .}$$

where the thermal sensitivity of the centroid wavelength is defined as a α≡Δλ̅/ΔT. Wavelength correction is advantageous to achieve such accuracy.

An optional second photodetector for detecting a portion of the light that is diverted from the coil for providing a means to measure the relative intensity noise (RIN) of the FOG is known in the art as a RIN photodetector.

Broadband light sources are particularly advantageous for introducing the light into the sensor coil because phase coherent noise effects due to backscattering noise and polarization coupling is suppressed, the RIN of the FOG decreases with increasing bandwidth, and the zero-rotation drift induced through the Kerr effect by relative variations in the two counterpropagating optical powers is reduced. Such effects would otherwise cause significant reduction in rotation sensitivity and accuracy. The relatively small size, low power consumption and low cost of SLDs are advantageous for many FOG applications. However, the inherent thermal sensitivity of the centroid wavelength thermal sensitivity α_{source} of SLDs is typically +250 to +400 ppm/° C., which is problematic for certain FOG applications even when thermoelectric cooling devices and other temperature compensation components, circuits and techniques are utilized. Consequently REDSLSs, such as erbium-doped fiber amplifiers, having significantly lower centroid wavelength thermal sensitivity have tended to find application in FOGs. For example, in D. C. Hall et al., “High-stability Er³⁺-doped superfluorescent fiber sources,” J. Lightwave Tech., Vol. 13, No. 7, pp. 1452-1460, July 1995, a centroid wavelength thermal sensitivity of 3-5 ppm/° C. is reported for an erbium-doped fiber amplifier type REDSLS.

In addition to FOGs, other optical sensors and measuring devices as known in the art, such as accelerometers, pressure sensors, strain sensors, temperature sensors, profilometers, fiber optic link test equipment, and optical coherence tomography systems, provide applications for which light sources enjoy utility and whereby the accuracy of the centroid wavelength is critical to performance. Various strategies for wavelength correction against environmental factors, such as ambient temperature, have been invoked to improve the accuracy of such sensors.

### SUMMARY

Applicants have recognized a need for an improved wavelength-corrective light source apparatus and method. Existing wavelength correction approaches, for example, require a relatively complicated set-up using accordingly relatively expensive components, bring about high optical losses, are bulky, or do not provide sufficient accuracy.

Accordingly, described herein are a wavelength-corrective light source apparatus and method.

In one embodiment, a wavelength-corrective light source apparatus includes a light source configured to emit light characterized by a wavelength spectrum having a centroid wavelength with a centroid wavelength operational sensitivity. The apparatus also includes a wavelength-sensitive photodetector having a unitary active area characterized by a plurality of different responsivity spectra. The wavelength-sensitive photodetector is configured to detect the light and to deliver a plurality of different wavelength constituent photocurrent signals in response to the detected light corresponding to the plurality of different responsivity spectra. The light source apparatus further includes a centroid wavelength correction circuit configured to receive and act on the plurality of different wavelength constituent photocurrent signals to compensate for the centroid wavelength operational sensitivity.

The plurality of different wavelength constituent photocurrent signals may have a nonlinearity with respect to the centroid wavelength, and the centroid wavelength correction circuit may include a nonlinearity cancellation member configured to cancel the nonlinearity.

The centroid wavelength correction circuit may include a centroid wavelength monitoring circuit configured to receive the plurality of different wavelength constituent photocurrent signals, the centroid wavelength monitoring circuit including a plurality of transimpedance amplifiers such that each transimpedance amplifier of the plurality of transimpedance amplifiers is configured to convert a respective one of the different wavelength constituent photocurrent signals of the plurality of different wavelength constituent photocurrent signals to a respective wavelength constituent voltage signal of a plurality of different wavelength constituent voltage signals.

At least one of the plurality of transimpedance amplifiers may be a logarithmic transimpedance amplifier. The centroid wavelength monitoring circuit can be further configured to operate on the plurality of different wavelength constituent voltage signals to deliver at least one voltage difference signal for use as a centroid wavelength monitor signal, the centroid wavelength correction circuit further comprising a centroid wavelength correction member configured to receive the at least one centroid wavelength monitor signal and to compensate for the operational sensitivity by delivering a compensation factor, based on the centroid wavelength monitor signal, for compensating for a discrepancy between the centroid wavelength and a predetermined reference wavelength.

The light source may be a broadband light source including at least one of a superluminescent diode (SLD), a rare-earth-doped superluminescent source (REDSLS), and a light emitting diode (LED), and the wavelength spectrum may have a FWHM bandwidth of about 5 nm or greater. The light source may instead be a narrowband light source including at least one of a laser, a laser diode (LD), and a tunable laser diode (TLD). The narrowband wavelength spectrum may have a full width at half maximum (FWHM) bandwidth less than about 5 nm.

The centroid wavelength operational sensitivity may include at least one of a centroid wavelength thermal sensitivity and a centroid wavelength drive current sensitivity.

The wavelength-sensitive photodetector may include at least one of (a) a photodetector comprised of at least two PN junctions formed at different depths from a unitary light-exposable surface of a semiconductor substrate, and (b) a photodetector that includes at least two photodiodes that are arranged in a cascade relationship.

The centroid wavelength correction circuit may be further configured to measure or adjust at least one of a bandwidth, asymmetry, and shape of the wavelength spectrum. The centroid wavelength correction circuit may include at least one of a microprocessor, an application-specific integrated circuit (ASIC), and a field-programmable gate array (FPGA).

The apparatus may further include an optical power monitor circuit configured deliver a total optical power monitor signal derived from the plurality of different wavelength constituent photocurrent signals, the total optical power monitor signal indicative of a total optical power incident upon wavelength-sensitive photodetector.

A fiber-optic gyroscope (FOG) may be configured to include the wavelength-corrective light source apparatus, in any of its variations, as described hereinabove. The FOG may include at least one of a coil of optical fiber, a rate detector, and a phase modulator coupler optical circuit configured to phase modulate the light from the light source and to couple the light from the light source into the coil of optical fiber and further into the at least one rate photodetector. The FOG may further include at least one relative intensity noise (RIN) photodetector.

In another embodiment, a wavelength-corrective fiber-optic gyroscope (FOG) apparatus includes a light source configured to emit light characterized by a wavelength spectrum having a centroid wavelength with a wavelength operational sensitivity. The FOG apparatus also includes a wavelength-sensitive photodetector having a unitary active area characterized by a plurality of different responsivity spectra. The wavelength-sensitive photodetector is configured to detect the light and to deliver a plurality of different wavelength constituent photocurrent signals in response to the detected light corresponding to the plurality of different responsivity spectra. The FOG apparatus also includes a centroid wavelength correction circuit configured to receive and act on the plurality of different wavelength constituent photocurrent signals to correct for the operational sensitivity. The FOG apparatus still further includes a light coupler configured to couple the light from the light source into a coil of optical fiber.

The centroid wavelength correction circuit may be further configured to correct for the operational sensitivity by compensating for the operational sensitivity. The centroid wavelength correction circuit may be further configured to correct for the operational sensitivity by controlling the centroid wavelength. The plurality of different wavelength constituent photocurrent signals may have a nonlinearity with respect to the centroid wavelength. The wavelength correction circuit may include a nonlinearity cancellation member configured to cancel the nonlinearity.

A further embodiment apparatus may include a light source configured to emit light characterized by a wavelength spectrum having a centroid wavelength; a wavelength-sensitive photodetector having a unitary active area characterized by a plurality of different responsivity spectra, the wavelength-sensitive photodetector configured to detect the light and to deliver a plurality of different wavelength constituent photocurrent signals in response to the detected light corresponding to the plurality of different responsivity spectra; a centroid wavelength monitoring circuit configured to receive the plurality of different wavelength constituent photocurrent signals, the centroid wavelength monitoring circuit comprising a plurality of transimpedance amplifiers such that each transimpedance amplifier of the plurality of transimpedance amplifiers is configured to convert a respective wavelength constituent photocurrent signal of the plurality of different wavelength constituent photocurrent signals to a respective wavelength constituent voltage signal of a plurality of different wavelength constituent voltage signals, the centroid wavelength monitoring circuit further configured to operate on the plurality of different wavelength constituent voltage signals to deliver at least one voltage difference signal, the at least one voltage difference signal configured to deliver a centroid wavelength monitor signal; and a centroid wavelength correction member configured to receive the at least one centroid wavelength monitor signal, the centroid wavelength correction member comprising at least one of a centroid wavelength compensator configured to deliver a compensation factor, based on the centroid wavelength monitor signal, for compensating for a discrepancy between the light centroid wavelength and a predetermined reference wavelength, and a centroid wavelength controller configured to deliver a control signal, based on the centroid wavelength monitor signal, to the light source to control the light centroid wavelength so that it matches a predetermined reference wavelength.

Embodiment methods described herein may include providing a light source, providing a wavelength-sensitive photodetector, providing a centroid wavelength monitoring circuit, providing a centroid wavelength correction member, and correcting the centroid wavelength of the light.

In a particular embodiment, a wavelength-corrective light source apparatus includes a light source configured to emit light characterized by a wavelength spectrum having a centroid wavelength, and further characterized by a centroid wavelength operational sensitivity. The apparatus also includes a wavelength-sensitive photodetector having a unitary active area characterized by a plurality of different responsivity spectra. The wavelength-sensitive photodetector is configured to detect the light and to deliver a plurality of different wavelength constituent photocurrent signals in response to the detected light corresponding to the plurality of different responsivity spectra. The apparatus also includes a centroid wavelength monitoring circuit. The centroid wavelength monitoring circuit is configured to receive the plurality of different wavelength constituent photocurrent signals. The centroid wavelength monitoring circuit comprises a plurality of transimpedance amplifiers. Each transimpedance amplifier of the plurality of transimpedance amplifiers is configured to convert a respective wavelength constituent photocurrent signal of the plurality of different wavelength constituent photocurrent signals to a respective wavelength constituent voltage signal of a plurality of different wavelength constituent voltage signals. The centroid wavelength monitoring circuit is further configured to operate on the plurality of different wavelength constituent voltage signals to deliver at least one voltage difference signal. The voltage difference signal is configured to deliver a centroid wavelength monitor signal. The apparatus also includes a centroid wavelength correction member configured to receive the at least one centroid wavelength monitor signal.

The light source may comprise a narrowband light source for emitting narrowband light. The narrowband light source may include at least one of a laser, a laser diode (LD), and a tunable laser diode (TLD). The narrowband light may be characterized by a spectrum having a full width at half maximum (FWHM) bandwidth less than about 5 nm.

Alternatively the light source may comprise a broadband light source for emitting broadband light. The broadband light source may include at least one of a superluminescent diode (SLD), a rare-earth-doped superluminescent source (REDSLS), and a light emitting diode (LED). The broadband light may be characterized by a spectrum having a full width at half maximum (FWHM) bandwidth of about 5 nm or greater.

The light source may include an output member comprising at least one of an aperture, window, lens, or fiber optic port. The light source may include at least one facet from which light is emitted. The at least one facet may comprise at least one of a front facet, the front facet configured to be proximal to the output member; and a back facet, the back facet configured to be distal to the output member.

The apparatus may further comprise a pick-off member for diverting a fraction of the light to the wavelength-sensitive photodetector. The pick-off member may include at least one of a beamsplitter, a mirror, a fiber optic coupler, and an integrated waveguide coupler.

The wavelength operational sensitivity may include at least one of a centroid wavelength thermal sensitivity and a centroid wavelength drive current sensitivity.

The wavelength-sensitive photodetector may include at least one of (a) a photodetector comprised of at least two PN junctions formed at different depths from a light-exposable surface of a semiconductor substrate whereby a deeper PN junction develops a wavelength constituent photocurrent signal related to longer wavelength component of the light impinging thereon and a shallower PN junction develops a different wavelength constituent photocurrent signal related to a different, shorter wavelength component of the impinging light; and (b) a photodetector comprised of at least two photodiodes that are arranged in a cascade relationship whereby a first photodiode is in a frontmost configuration with respect to incident light and at least a second photodiode is in a rear configuration with respect to incident light such that the responsivity spectrum of the at least one rear photodiode has a responsivity peak that corresponds to longer wavelengths than a different responsivity peak of the one frontmost photodiode that corresponds to shorter wavelengths due to at least one of (i) the first photodiode acting as a long wavepass spectral filter over the second photodiode and (ii) the first and second photodiodes being comprised of different materials having different spectral photosensitivities.

The wavelength-sensitive photodetector may be configured to detect light emitted from the front facet of the light source. Alternatively the wavelength-sensitive photodetector may be configured to detect light emitted from the back facet of the light source.

The wavelength-sensitive photodetector may be configured to detect light provided from an output member of the light source.

The plurality of transimpedance amplifiers may include at least one logarithmic transimpedance amplifier for logarithmic conversion of at least one wavelength constituent photocurrent signal to at least one wavelength constituent voltage signal.

In a preferred embodiment the plurality of transimpedance amplifiers is comprised entirely of a plurality of logarithmic transimpedance amplifiers.

The centroid wavelength monitoring circuit may further include at least one difference amplifier for subtraction of a first wavelength constituent voltage signal of the plurality of wavelength constituent voltage signals from a second wavelength constituent voltage signal of the plurality of wavelength constituent voltage signals to deliver the at least one voltage difference signal.

The centroid wavelength monitoring circuit may further comprise at least one nonlinearity cancellation member configured to cancel a nonlinear dependence of the at least one voltage difference signal with respect to the wavelength spectrum of the light.

The centroid wavelength monitoring circuit may further be optimized with respect to a range of characteristics of the wavelength spectrum including bandwidth, asymmetry, and overall shape.

The apparatus may further be configured to monitor the total optical power incident upon the wavelength-sensitive photodetector.

The centroid wavelength correction member may comprise a centroid wavelength compensator configured to deliver a compensation factor, based on the centroid wavelength monitor signal, for compensating for a discrepancy between the light centroid wavelength and a predetermined reference wavelength due to the centroid wavelength operational sensitivity. Alternatively, the centroid wavelength correction member may comprise a centroid wavelength controller configured to deliver a control signal, based on the centroid wavelength monitor signal, to the light source to control the light centroid wavelength against the operational sensitivity so that the light centroid wavelength matches a predetermined reference wavelength.

The centroid wavelength correction member may include at least one of a microprocessor, an application-specific integrated circuit (ASIC), a field-programmable gate array (FPGA), and a wavelength control circuit.

The centroid wavelength correction member may be configured either internal or external to the housing.

A fiber-optic gyroscope (FOG) may include the wavelength-corrective light source apparatus. The FOG may also include at least one coil of optical fiber, at least one rate detector, and at least one phase modulator coupler optical circuit configured to phase modulate the light from the apparatus and couple the light from the apparatus into the at least one coil of optical fiber and further into the at least one rate photodetector. The FOG may further include at least one optional RIN photodetector. The at least one rate photodetector and the at least one optional RIN photodetector may each comprise a wavelength-sensitive photodetector of the wavelength-corrected light source apparatus.

In another embodiment, a method of correcting a light source wavelength includes detecting emitted light at a unitary active area of a wavelength-sensitive photodetector. The unitary active area is characterized by a plurality of different responsivity spectra, and the emitted light is characterized by a wavelength spectrum having a centroid wavelength with a wavelength operational sensitivity. The method further includes delivering, from the wavelength-sensitive photodetector, a plurality of different wavelength constituent photocurrent signals in response to the detected light corresponding to the plurality of different responsivity spectra. The method also includes compensating for the wavelength operational sensitivity by acting on the plurality of different wavelength constituent photocurrent signals. The method may further optionally include any of the other features described herein in relation to other embodiments.

In another embodiment, a method for correcting the centroid wavelength of light from a light source includes providing a light source whose light is characterized by a wavelength spectrum having a centroid wavelength, and further characterized by a centroid wavelength operational sensitivity. The method also includes providing a wavelength-sensitive photodetector having a unitary active area characterized by a plurality of different responsivity spectra. The method also includes providing a wavelength monitoring circuit. The method also includes providing a centroid wavelength correction member. The method also includes correcting the centroid wavelength of the light against the centroid wavelength operational sensitivity. The method may also include providing a pick-off member.

Providing the light source can include providing at least one of a laser, an LD, a TLD, a SLD, a REDSLS, and an LED.

Providing the wavelength-sensitive photodetector can include providing at least one of (a) a photodetector comprised of at least two PN junctions formed at different depths from a light-exposable surface of a semiconductor substrate whereby a deeper PN junction develops a wavelength constituent photocurrent signal related to longer wavelength component of the light impinging thereon and a shallower PN junction develops a different wavelength constituent photocurrent signal related to different, shorter wavelength component of the impinging light; and (b) a photodetector comprised of at least two photodiodes that are arranged in a cascade relationship whereby a first photodiode is in a frontmost configuration with respect to incident light and at least a second photodiode is in a rear configuration with respect to incident light such that the responsivity spectrum of the at least one rear photodiode has a different responsivity peak that corresponds to longer wavelengths than a responsivity peak of the one frontmost photodiode that corresponds to shorter wavelengths due to at least one of (i) the first photodiode acting as a long wavepass spectral filter over the second photodiode and (ii) the first and second photodiodes being comprised of different materials having different spectral photosensitivities.

Providing the wavelength monitoring circuit can include providing a plurality of transimpedance amplifiers. The plurality of transimpedance amplifiers may include at least one logarithmic transimpedance amplifier. In a preferred embodiment, providing the wavelength monitoring circuit includes providing a plurality of logarithmic transimpedance amplifiers.

Providing the centroid wavelength monitoring circuit may further include providing at least one difference amplifier.

Providing the centroid wavelength monitoring circuit may further include providing at least one nonlinearity cancellation member.

The method may further comprise optimizing the centroid wavelength monitoring circuit with respect to a range of characteristics of the wavelength spectrum including bandwidth, asymmetry, and overall shape.

The method may further comprise monitoring the total optical power incident upon the wavelength-sensitive photodetector.

Providing the centroid wavelength correction member can include at least one of providing a wavelength compensator and providing a wavelength controller.

Correcting the centroid wavelength of the source light can include at least one of delivering a compensation factor for the light centroid wavelength and controlling the light source to control the light centroid wavelength.

In yet another embodiment, a method of optimizing a FOG includes supplying the light from any embodiment wavelength-corrective light source apparatus described herein. The method also includes phase modulating the light and optically coupling the light into a coil of optical fiber. The method may also include applying the wavelength-sensitive photodetector as at least one of a rate detector of the FOG and a RIN detector of the FOG.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

For a fuller understanding of the nature and objects of the disclosed embodiments, reference should be made to the following detailed description, taken in connection with the accompanying drawings, in which:

FIG. 1A is a schematic diagram of a wavelength-corrective light source apparatus comprising a wavelength compensator;

FIG. 1B is a schematic diagram of a wavelength-corrective light source apparatus comprising a wavelength controller;

FIG. 2 is a schematic diagram of a light source of the apparatus shown in FIGS. 1A and 1B;

FIG. 3 is a schematic diagram of a wavelength-sensitive photodetector of the apparatus shown in FIGS. 1A and 1B;

FIG. 4 is a schematic diagram of an alternative wavelength-sensitive photodetector of the apparatus shown in FIGS. 1A and 1B;

FIG. 5 is a circuit diagram of an equivalent circuit of the wavelength-sensitive photodetector of FIGS. 3 and 4;

FIG. 6 shows an example of two different responsivity spectra of the wavelength-sensitive photodetector of FIGS. 3 and 4;

FIG. 7A is a circuit diagram of a centroid wavelength monitoring circuit of the apparatus shown in FIGS. 1A and 1B;

FIG. 7B is an alternative circuit diagram of a centroid wavelength monitoring circuit of the apparatus shown in FIGS. 1A and 1B;

FIGS. 8A and 8B show exemplary plots and fits of centroid wavelength discrepancy vs. voltage difference signal;

FIGS. 9A and 9B show plots of the centroid wavelength error of the centroid wavelength monitor signal vs. centroid wavelength discrepancy corresponding to the difference between the plots and fits shown in FIGS. 8A and 8B;

FIG. 10 shows the combination of the plots of FIGS. 8A and 8B, and fits of centroid wavelength discrepancy vs. voltage difference signal for the combination of plots;

FIGS. 11A and 11B show plots of the centroid wavelength error of the centroid wavelength monitor signal vs. centroid wavelength discrepancy corresponding to the difference between the plots and fits shown in FIG. 10;

FIG. 12 is a schematic diagram of an embodiment of the wavelength-corrective light source apparatuses of FIGS. 1A and 1B that further comprises a pick-off member;

FIG. 13 is a schematic diagram of an embodiment of the wavelength-corrective light source apparatuses of FIGS. 1A and 1B that is further configured to monitor total optical power;

FIG. 14 is a schematic diagram of a fiber-optic gyroscope (FOG) comprising the wavelength-corrective light source apparatus; and

FIG. 15 is a schematic diagram of another fiber-optic gyroscope (FOG) comprising the wavelength-corrective light source apparatus.

FIG. 16 is a flow diagram illustrating an embodiment procedure for correcting a centroid wavelength of a light source.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION

A description of example embodiments of the invention follows. The following is a detailed description of the preferred embodiments of the invention, reference being made to the drawings in which the same reference numerals identify the same elements of structure in each of the several figures.

Figures shown and described herein are provided in order to illustrate key principles of operation and component relationships along their respective optical paths according to the present disclosure and are not drawn with intent to show actual size or scale. Some exaggeration may be necessary in order to emphasize basic structural relationships or principles of operations.

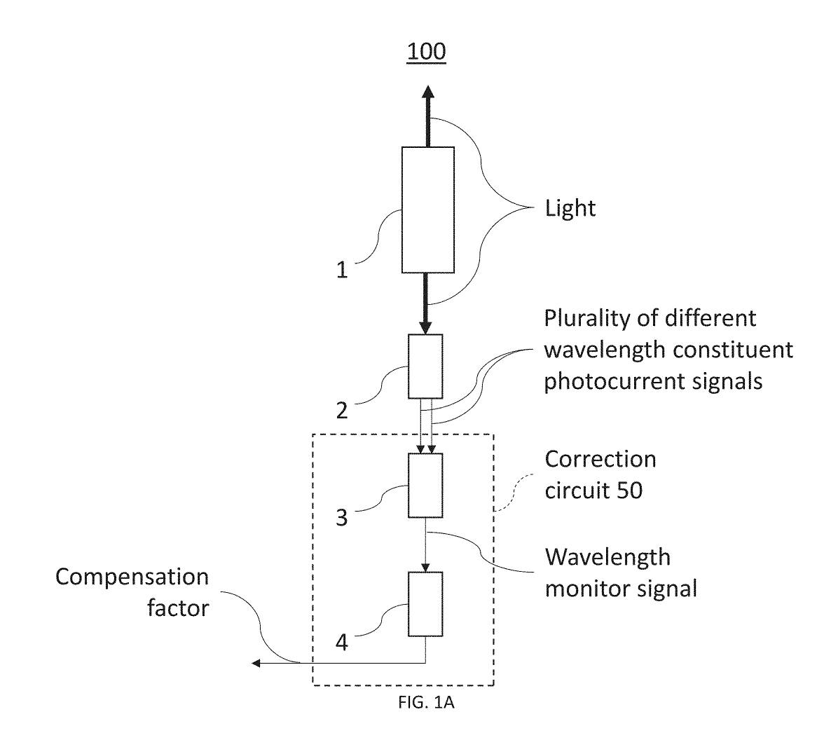

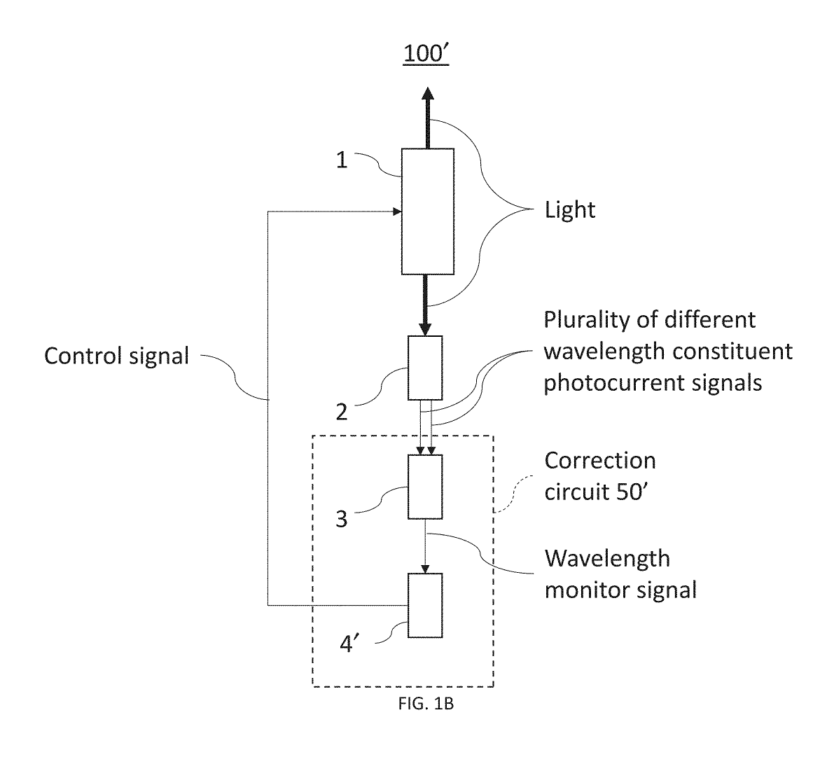

FIG. 1A is a schematic diagram of wavelength-corrective light source apparatus 100 comprising light source 1, wavelength-sensitive photodetector 2 having a unitary active area characterized by a plurality of responsivity spectra, centroid wavelength monitoring circuit 3, and centroid wavelength correction member 4. The centroid wavelength monitoring circuit 3 and centroid wavelength correction member 4 together form a centroid wavelength correction circuit 50. Consistent with other embodiments disclosed herein and illustrated in the drawings, centroid wavelength correction circuits may include fewer or additional features.

Light source 1 is configured to emit light. The light is characterized by a wavelength spectrum having a centroid wavelength. The light is further characterized by a centroid wavelength operational sensitivity. The centroid wavelength operational sensitivity may include at least one of a centroid wavelength thermal sensitivity and a centroid wavelength drive current sensitivity, for example. As used herein, a centroid wavelength thermal sensitivity denotes that a centroid wavelength of the light that is output from the light source 1 varies with an ambient temperature surrounding the light source 1 or with a temperature at which the light source 1 is held. As used herein, a centroid wavelength drive current sensitivity denotes that the centroid wavelength of the light that is output from the light source 1 varies with drive current for the light source 1.

Wavelength-sensitive photodetector 2 is configured to detect the light and to deliver a plurality of different wavelength constituent photocurrent signals in response to the detected light. Centroid wavelength monitoring circuit 3 is configured to receive the plurality of wavelength constituent photocurrent signals and to deliver at least one centroid wavelength monitor signal. Centroid wavelength correction member 4 comprises a centroid wavelength compensator and is configured to receive the centroid wavelength monitor signal and to deliver a compensation factor, based on the centroid wavelength monitor signal, for compensating for a discrepancy between the light centroid wavelength and a predetermined reference wavelength due to the centroid wavelength operational sensitivity.

One example compensation factor is the ratio of the light centroid wavelength and the predetermined reference wavelength that is multiplied by a raw output of a sensor, such as a fiber optic gyroscope, that uses apparatus 100 to deliver a corrected output. The ratio may be calculated by the centroid wavelength compensator by means of a calibrated look-up table based on a numerical fit or analytical relationship of the centroid wavelength monitor signal to the actual light centroid wavelength. The numerical fit or analytical relationship may be a linear. Alternatively, the numerical fit or analytical relationship may be a nonlinear, for example characterized by a polynomial of order two or greater, such as quadratic, cubic, quartic, etc. In view of the description provided herein, a person of ordinary skill in the art would be enabled to cause compensation in embodiments in a variety of other manners.

FIG. 1B is a schematic diagram of wavelength-corrective light source apparatus 100′ wherein a centroid wavelength correction member 4′ comprises a centroid wavelength controller and is configured to receive the centroid wavelength monitor signal and to deliver a control signal, based on the centroid wavelength monitor signal, to light source 1 to control the light centroid wavelength against the operational sensitivity so that the light centroid wavelength matches a predetermined reference wavelength. The centroid wavelength monitoring circuit 3 and centroid wavelength correction member 4′ together form a centroid wavelength correction circuit 50′. Consistent with other embodiments disclosed herein and illustrated in the drawings, centroid wavelength correction circuits may include fewer or additional features.

In accordance with various embodiments disclosed herein, and in view of the disclosure provided herein, the light centroid wavelength may be controlled by means known in the art that can include at least one of a thermal conditioning device, such as a Peltier cell, configured to receive the control signal and to adjust the temperature of the light source 1 to control the light centroid wavelength; an electrical current conditioning device configured to receive the control signal and adjust the drive current supplied to light source 1 to control the light centroid wavelength; and an external mirror conditioning device configured to receive the control signal and adjust an external mirror reflectivity or position.

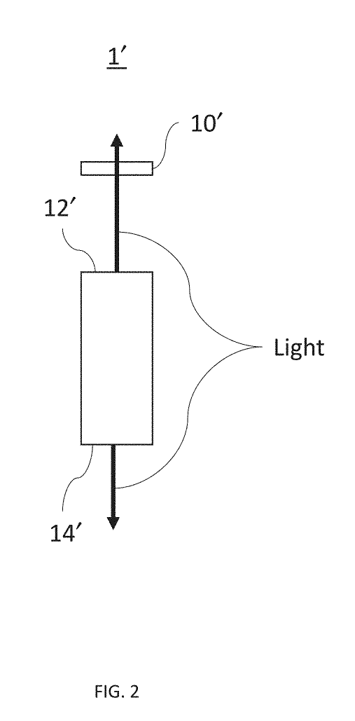

FIG. 2 is a schematic diagram of an embodiment of light source 1 of FIGS. 1A and 1B shown as light source 1′. Light source 1′ may comprise a narrowband light source for emitting narrowband light. The narrowband light source may include at least one of a laser, a laser diode (LD), and a tunable laser diode (TLD). The narrowband light may be characterized by a spectrum having a full width at half maximum (FWHM) bandwidth less than about 5 nm. Alternatively, light source 1′ may comprise a broadband light source for emitting broadband light. The broadband light source may include at least one of a superluminescent diode (SLD), a rare-earth-doped superluminescent source (REDSLS), and a light emitting diode (LED). The broadband light may be characterized by a spectrum having a full width at half maximum (FWHM) bandwidth of about 5 nm or greater. Light source 1′ includes an output member 10′ comprising at least one of an aperture, window, lens, or fiber optic port. Light source 1′ includes front facet 12′, the front facet configured to be proximal to the output member; and back facet 14′, the back facet configured to be distal to the output member.

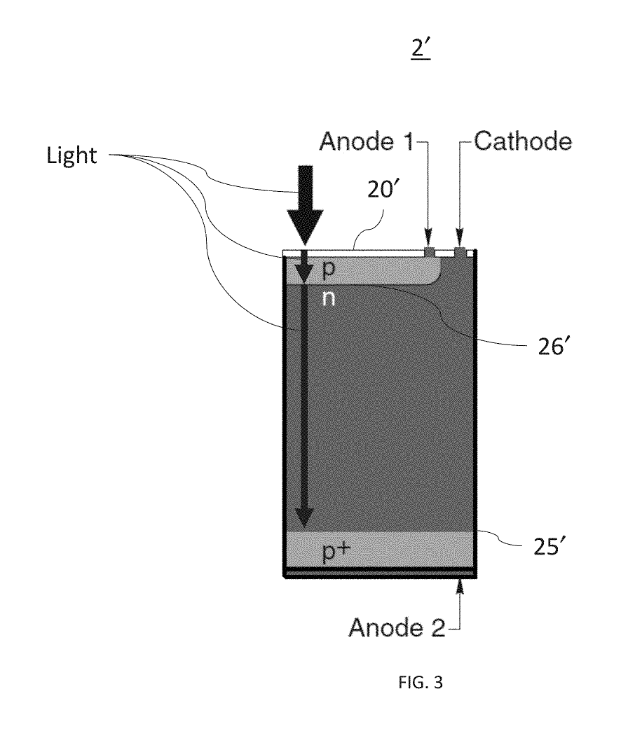

FIG. 3 is a cross-sectional schematic diagram of an embodiment of wavelength-sensitive photodetector 2 of FIGS. 1A and 1B, shown as wavelength-sensitive photodetector 2′. Wavelength-sensitive photodetector 2′ comprises a first PN junction 25′ and a second PN junction 26′, each formed at a different depth below a light-exposable surface comprising a unitary active area 20′ of wavelength-sensitive photodetector 2′. First PN junction 25′ is deeper and hence develops a wavelength constituent photocurrent signal related to longer wavelength component of the light impinging thereon and second PN junction 26′ is shallower and hence develops a different wavelength constituent photocurrent signal related to a different, shorter wavelength component of the impinging light. Known examples of wavelength-sensitive photodetector 2′ include the photodetector described in U.S. Pat. No. 4,309,604 to Yoshikawa et al., which is hereby incorporated herein by reference in its entirety, and the commercial silicon photodetector available from First Sensor, Berlin, Germany, and designated WS7.56, for example.

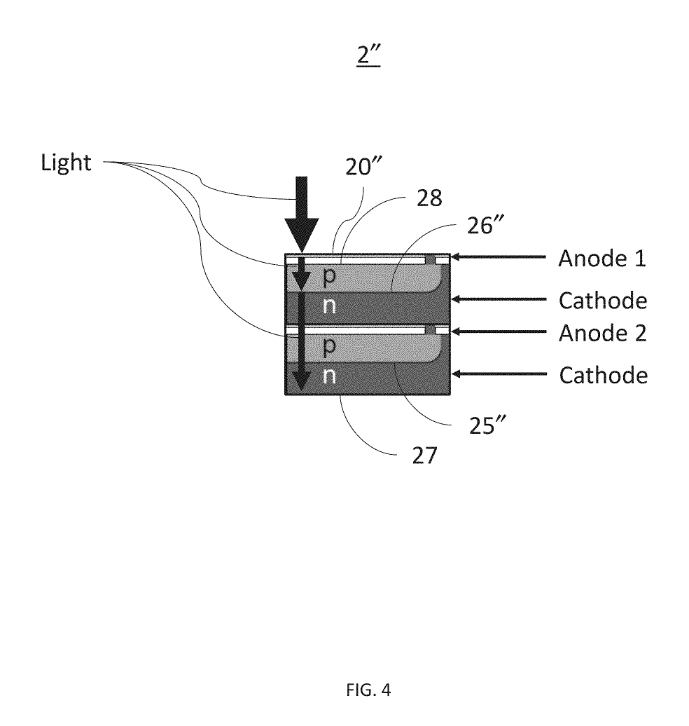

FIG. 4 is a cross-sectional schematic diagram of another embodiment of wavelength-sensitive photodetector 2 of FIGS. 1A and 1B, shown as wavelength-sensitive photodetector 2″. Wavelength-sensitive photodetector 2″ comprises a first photodiode 27 having a first PN junction 25″, and a second photodiode 28 having a second PN junction 26″ that is formed at a depth below a light-exposable surface comprising a unitary active area 20″ of wavelength-sensitive photodetector 2″. First photodiode 27 and second photodiode 28 are arranged in a cascade relationship whereby second photodiode 28 is in a frontmost configuration with respect to incident light and first photodiode 27 is in a rear configuration with respect to incident light such that the responsivity spectrum of first photodiode 27 has a responsivity peak that corresponds to longer wavelengths than a different responsivity peak of second photodiode 28 that corresponds to shorter wavelengths due to at least one of (i) second photodiode 28 acting as a long wavepass spectral filter over first photodiode 27 and (ii) first photodiode 27 and second photodiode 28 being comprised of different materials having different spectral photosensitivities. Known examples of wavelength-sensitive photodetector 2″ include the photodetector described in U.S. Pat. No. 3,962,578 to Roschen, which is hereby incorporated herein by reference in its entirety, or any of the commercial photodetectors available from Electro-Optical Systems Inc., Phoenixville, Pa., and designated 2-color detectors.

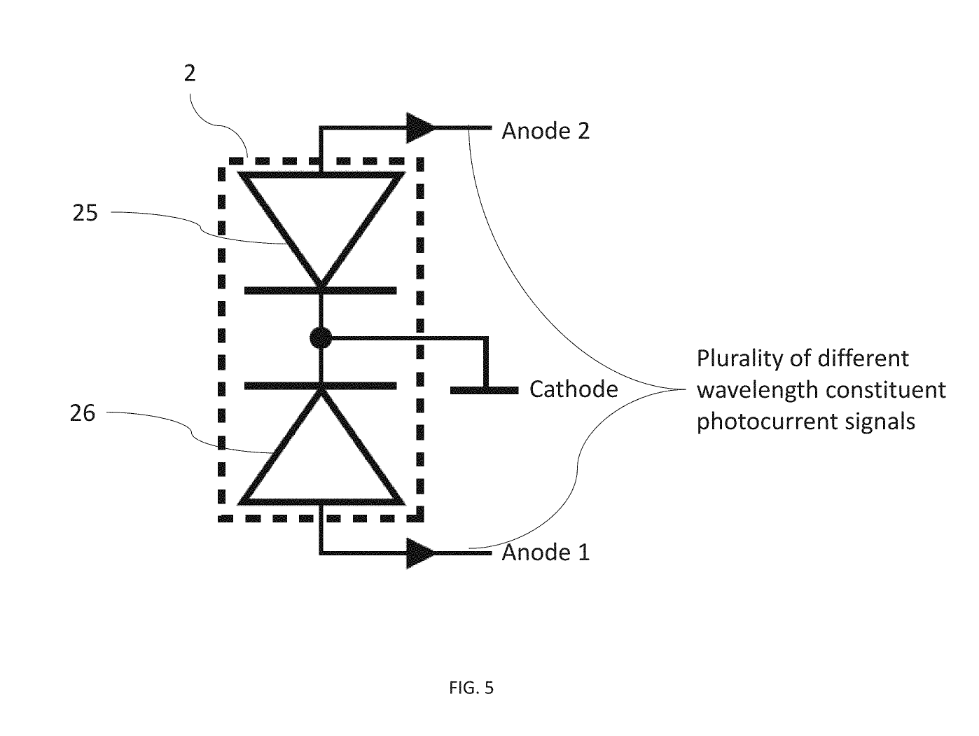

It should be understood that the detectors of FIGS. 4-5 with a “unitary active area” differ from multi-pixel or dispersion-based detectors. As used herein, in detectors with a “unitary active area,” all the wavelengths corresponding to the different spectral regions impinge on the “active area” over which the detectors of FIGS. 4-5 receive light. It will be understood, further in reference to FIGS. 4-5, that the various PN junctions, which are sensitive to different respective wavelength constituents, receive light through the same unitary active area.

FIG. 5 is a circuit diagram of an equivalent circuit of the embodiments of wavelength-sensitive photodetector 2 shown in FIGS. 3 and 4 wherein PN junction 25 represents PN junction embodiments 25′ and 25″ and PN junction 26 represents PN junction embodiments 26′ and 26″. Wavelength-sensitive photodetector 2 is configured to detect the light and to deliver a plurality of different wavelength constituent photocurrent signals in response to the detected light.

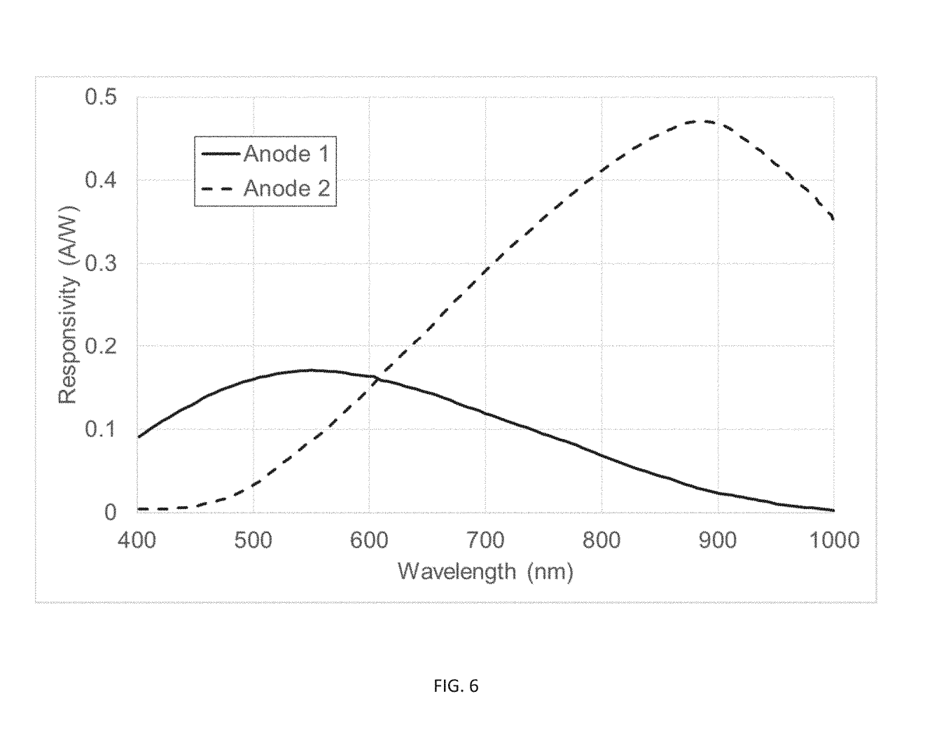

FIG. 6 shows an example of two different responsivity spectra of the embodiments of wavelength-sensitive photodetector 2 shown in FIGS. 3 and 4. The spectrum shown for Anode 1 is peaked toward shorter wavelengths and the spectrum shown for Anode 2 is peaked toward longer wavelengths. The exemplary responsivity spectra shown in FIG. 6 correspond to those of the commercial silicon photodetector available from First Sensor, Berlin, Germany, and designated WS7.56.

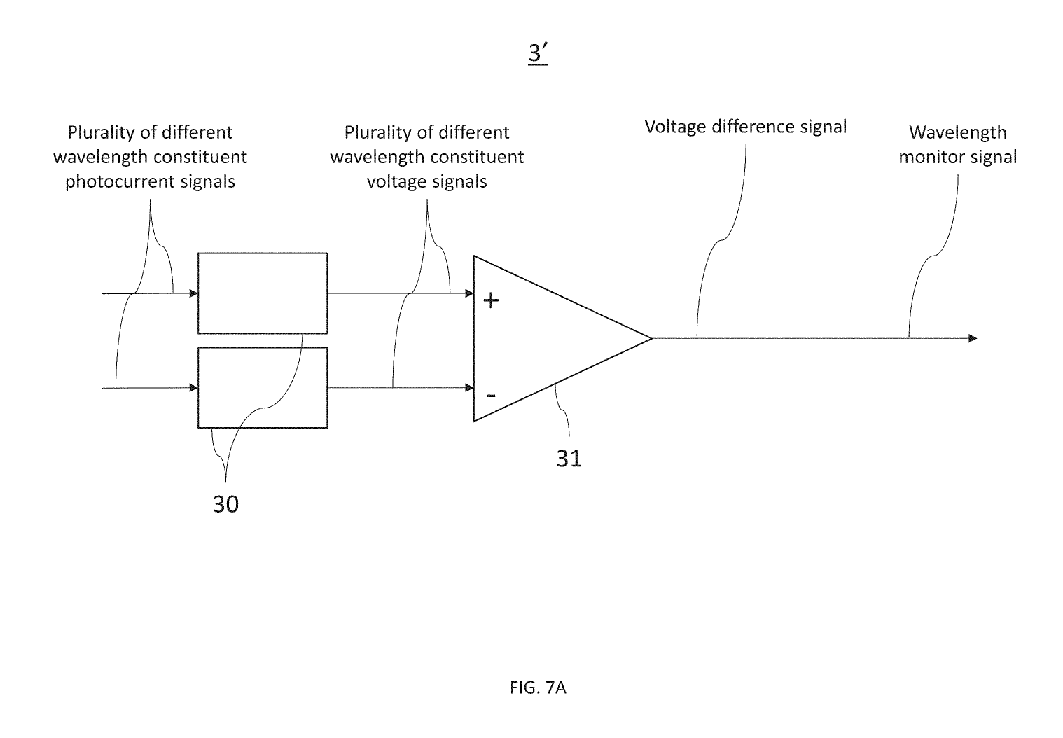

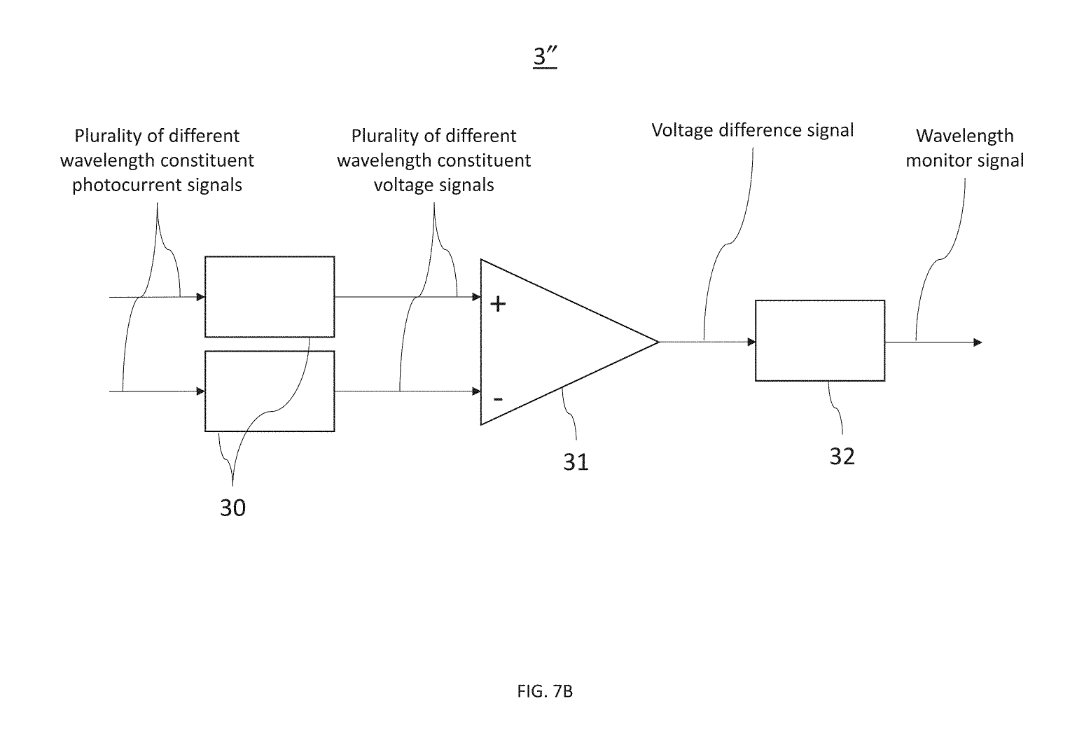

FIG. 7A is a circuit diagram of an embodiment of centroid wavelength monitoring circuit 3 shown in FIGS. 1A and 1B, shown as wavelength monitoring circuit 3′. Centroid wavelength monitoring circuit 3′ comprises plurality of two logarithmic transimpedance amplifiers 30. Each logarithmic transimpedance amplifier of plurality of two logarithmic transimpedance amplifiers 30 is configured to convert a respective wavelength constituent photocurrent signal of a plurality of two different wavelength constituent photocurrent signals to a respective wavelength constituent voltage signal of a plurality of two different wavelength constituent voltage signals. Centroid wavelength monitoring circuit 3′ further comprises difference amplifier 31 that operates on the plurality of two different wavelength constituent voltage signals to deliver a voltage difference signal by performing a subtraction of a first wavelength constituent voltage signal of the plurality of two different wavelength constituent voltage signals, for example the wavelength constituent voltage signal that corresponds to the wavelength constituent photocurrent delivered by Anode 1 of PN junction 26 that corresponds to shorter wavelengths, from a second wavelength constituent voltage signal of the plurality of two different wavelength constituent voltage signals, for example the wavelength constituent voltage signal that corresponds to the wavelength constituent photocurrent delivered by Anode 2 of PN junction 25 that corresponds to longer wavelengths. The voltage difference signal is a centroid wavelength monitor signal.

FIG. 7B is a circuit diagram of an alternative embodiment of centroid wavelength monitoring circuit 3 shown in FIGS. 1A and 1B, shown as centroid wavelength monitoring circuit 3″. Centroid wavelength monitoring circuit 3″ is based on centroid wavelength monitoring circuit 3′ of FIG. 7A but further includes nonlinearity cancellation member 32 configured to receive the voltage difference signal, to cancel a nonlinear dependence of the voltage difference signal with respect to the wavelength spectrum of the light, and to deliver a centroid wavelength monitor signal. Nonlinearity cancellation member 32 may comprise at least one of a digital circuit comprising, for example, an analog-to-digital converter and an FPGA; and an analog circuit comprising, for example, an analog multiplier and a summing amplifier.

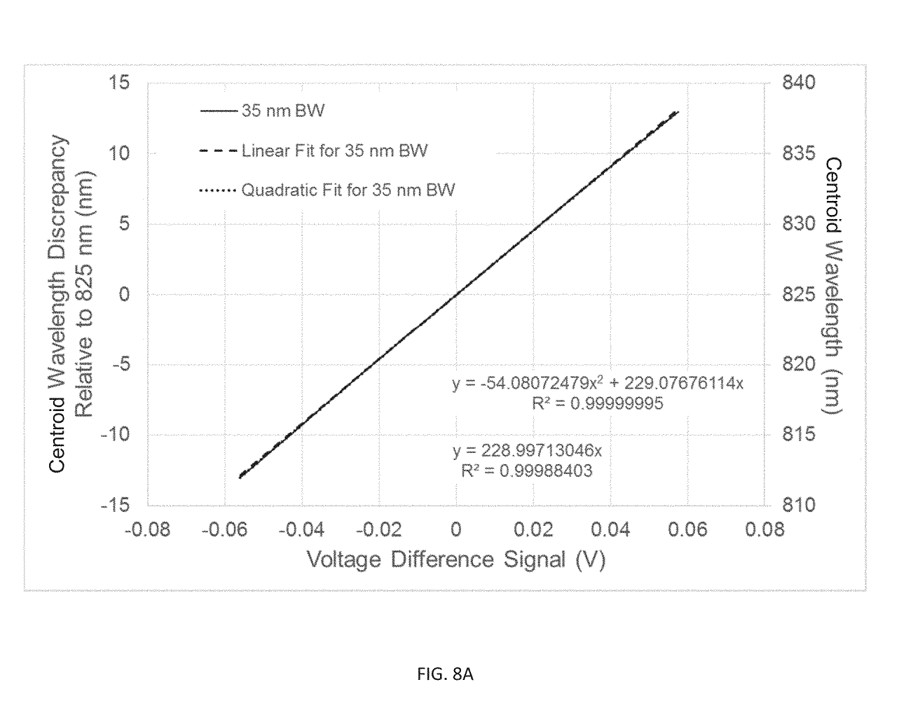

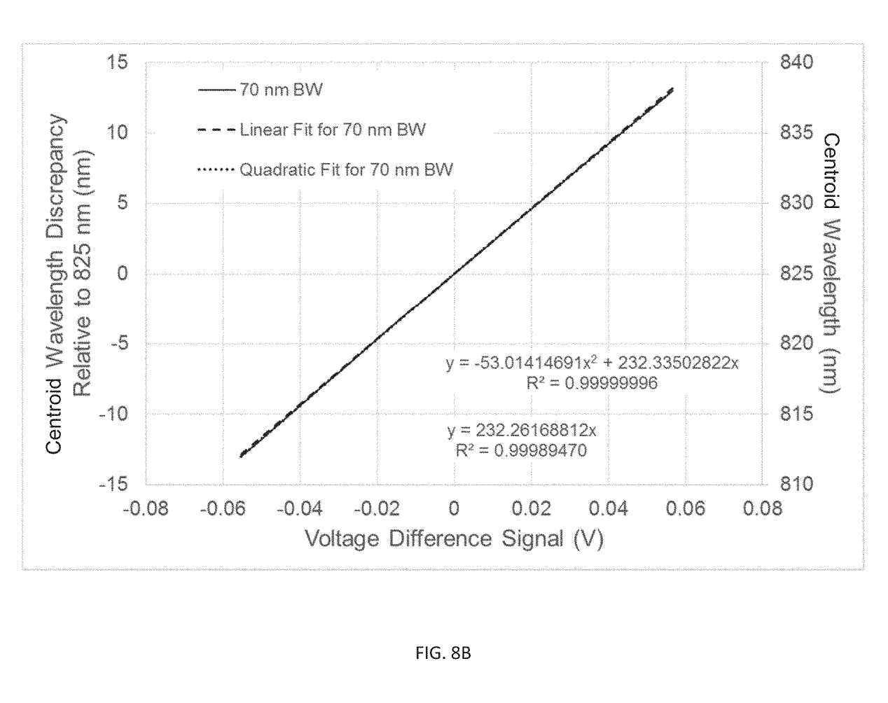

Nonlinearities such as those described in connection with FIGS. 8A-8B, 9A-9B, 10, and 11A-11B associated with the transimpedance amplifiers used in centroid wavelength monitoring circuit 3 shown in FIGS. 1A-1B and various embodiments may be cancelled using the nonlinearity cancellation member 32, for example. As a system such as a FOG operates, the voltage difference signal may be measured with transimpedance amplifier 31. Nonlinearity cancellation member 32 may have an analog-to-digital converter that digitizes the voltage difference signal, and an FPGA that calculates the centroid wavelength monitor signal as a nonlinear function of the voltage difference signal. The nonlinearity cancellation member 32 may also output the centroid wavelength monitor signal as an analog or digital signal to light source 1 (or to a driver for light source 1) to adjust centroid wavelength appropriately. In view of the description herein, a person of ordinary skill in the art will further recognize that nonlinear cancellation may be effected in other ways not specifically described herein by appropriate control of light source 1 based on the nonlinear cancellation member. While wavelength-sensitive photodiodes such as those described herein may have inherent nonlinearities, there may also be nonlinearities arising from other components within embodiments, and these nonlinearities from various components may be advantageously corrected using cancellation member 32, for example.

FIGS. 8A and 8B show exemplary plots of centroid wavelength discrepancy (solid line), as indicated with the left vertical axis, between the actual centroid wavelength of the light, as indicated with the right vertical axis, and an exemplary predetermined reference wavelength of 825 nm, vs. voltage difference signal. The centroid wavelength discrepancy axis is centered at 0 nm, corresponding to a centroid wavelength of 825 nm, and ranges from −13 nm, corresponding to a centroid wavelength of 812 nm, to +13 nm, corresponding to a centroid wavelength of 838 nm. Such centroid wavelength discrepancy may arise, for example, from an operational sensitivity such as a centroid wavelength thermal sensitivity of 0.226 nm/° C., or 274 ppm/° C., over a range of ±57.5° C. centered at a reference temperature corresponding to the reference wavelength of 825 nm; such a centroid wavelength thermal sensitivity is typical for SLDs.

In each of FIGS. 8A and 8B, the plots are the results of simulations based on the two different responsivity spectra shown in FIG. 6, whereby the voltage difference signal is biased such that a voltage difference signal level of zero corresponds to the predetermined reference wavelength. Example voltage difference signals are illustrated in schematic system diagrams in FIGS. 7A-7B, for example. FIG. 8A shows an example wherein the source light has a bandwidth (BW), also known as full width at half maximum (FWHM), of 35 nm. FIG. 8B shows an example wherein the source light has a BW of 70 nm. Each of FIGS. 8A and 8B further includes both a linear fit (dashed line) and a quadratic fit (dotted line) to the respective plot of wavelength discrepancy vs. voltage difference signal (solid line). In each case, the intercept of the fit is constrained to be zero. The fit results, including the fit equations and coefficients of determination, or R² values, are shown in each of FIGS. 8A and 8B. The R² value corresponding to quadratic fit is greater that the corresponding R² values corresponding to linear fit for each of the graphs.

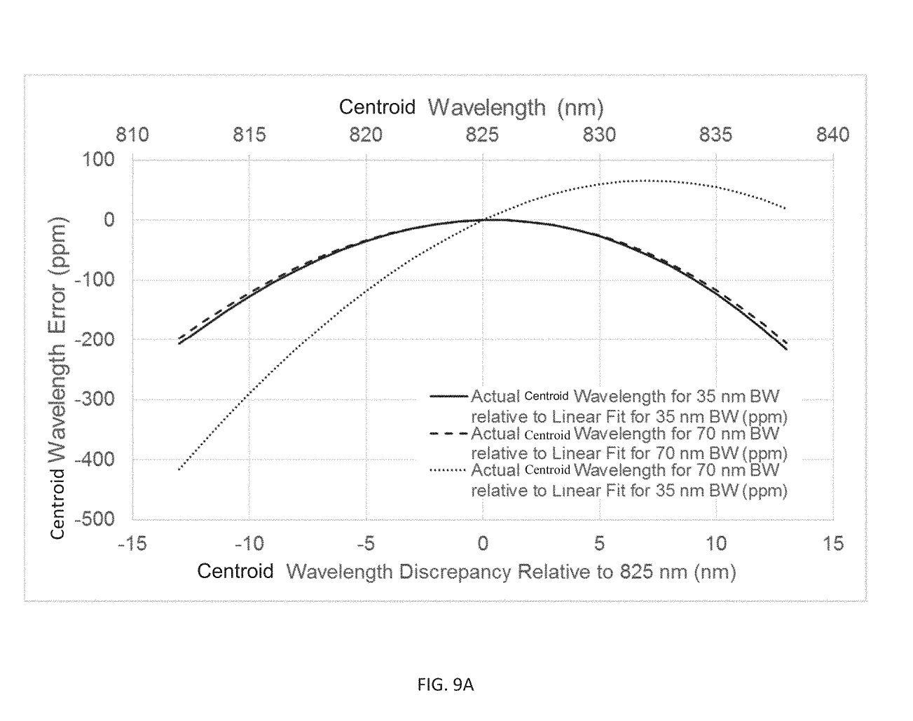

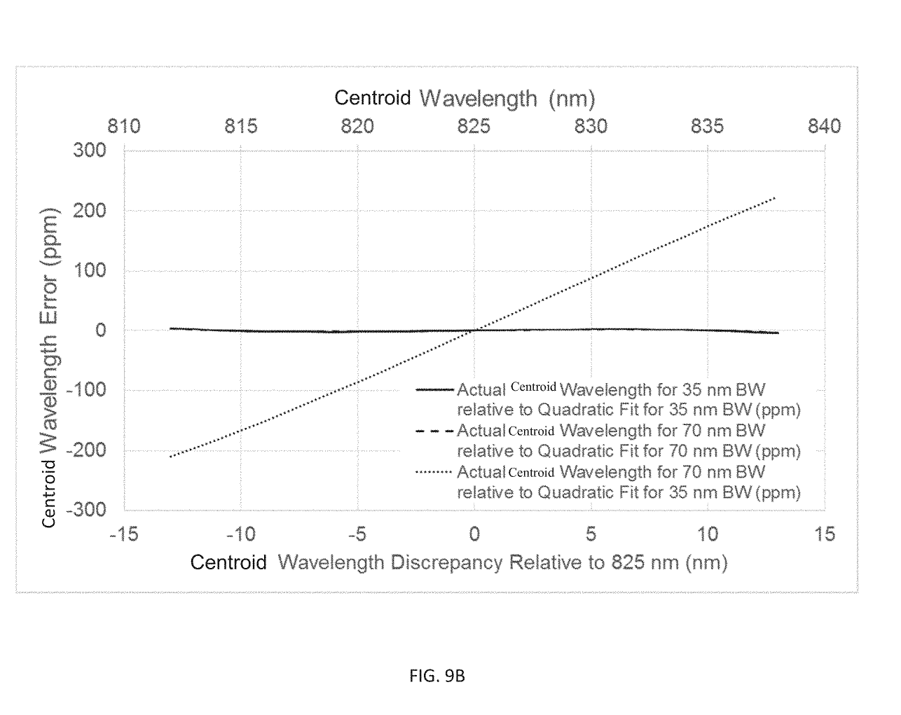

FIGS. 9A and 9B show plots of the centroid wavelength error of the centroid wavelength monitor signal vs. centroid wavelength discrepancy corresponding to the difference between the plots and respective fits shown in FIGS. 8A and 8B. The centroid wavelength error shown in FIG. 9A corresponds to the difference between the plots and respective linear fits shown in FIGS. 8A and 8B, corresponding to centroid wavelength monitoring circuit 3′ that does not include a nonlinearity cancellation member. The centroid wavelength error shown in FIG. 9B corresponds to the difference between the plots and respective quadratic fits shown in FIGS. 8A and 8B, for 35 nm and 70 nm BW, respectively, corresponding to centroid wavelength monitoring circuit 3″ that includes a nonlinearity cancellation member configured for quadratic cancellation.

In addition, plots of the centroid wavelength error of the centroid wavelength monitor signal corresponding to the difference between the plots for 70 nm BW and the respective fits for 35 nm BW are shown in FIGS. 9A and 9B. The centroid wavelength error shown in FIG. 9A is as much as about 200 ppm (parts per million) in magnitude at the extremes of the centroid wavelength discrepancy range, and as much as about 400 ppm for the case where the linear fit equation for 35 nm BW is compared against the 70 nm BW plot. In comparison, the centroid wavelength error shown in FIG. 9B is only as much as about 4 ppm in magnitude at the extremes of the centroid wavelength discrepancy range, and only as much as about 200 ppm for the case where the quadratic fit equation for 35 nm BW is compared against the 70 nm BW plot, thereby showing the benefit of nonlinearity cancellation.

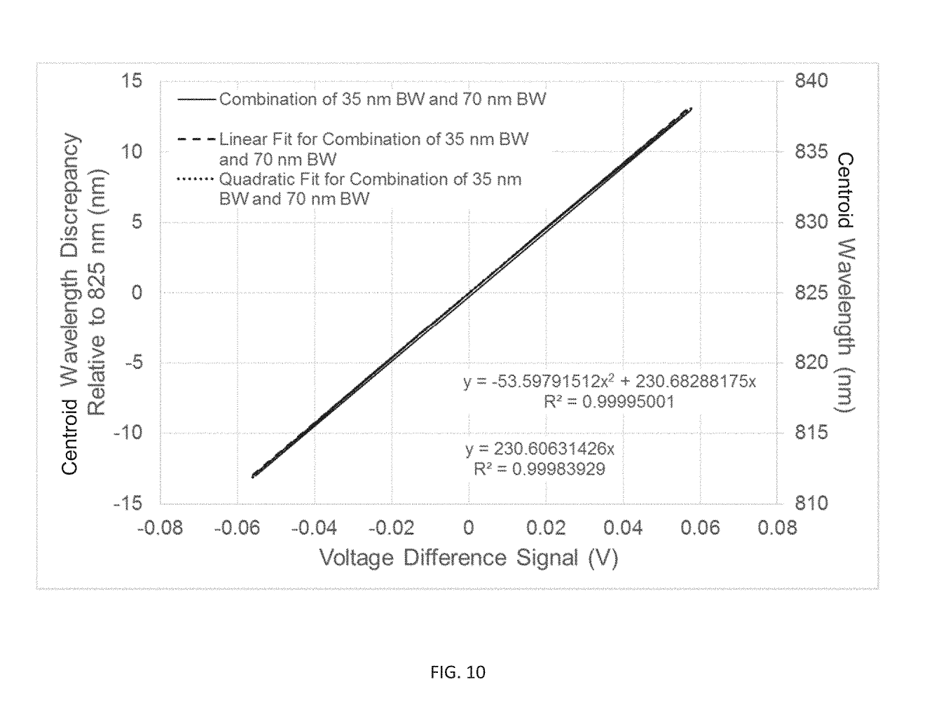

FIG. 10 shows the combination of the 35 nm BW plot of FIG. 8A and the 70 nm BW plot of FIG. 8B, and both a linear fit and a quadratic fit to the combination of plots as examples of optimizing centroid wavelength monitoring circuit 3′ or 3″ with respect to a range of characteristics of the wavelength spectrum, in this case bandwidth, also known as FWHM, but also applicable to asymmetry and overall shape. In each case the intercept of the fit is constrained to be zero. The fit results, including the fit equations and coefficients of determination, or R² values, are shown in FIG. 10.

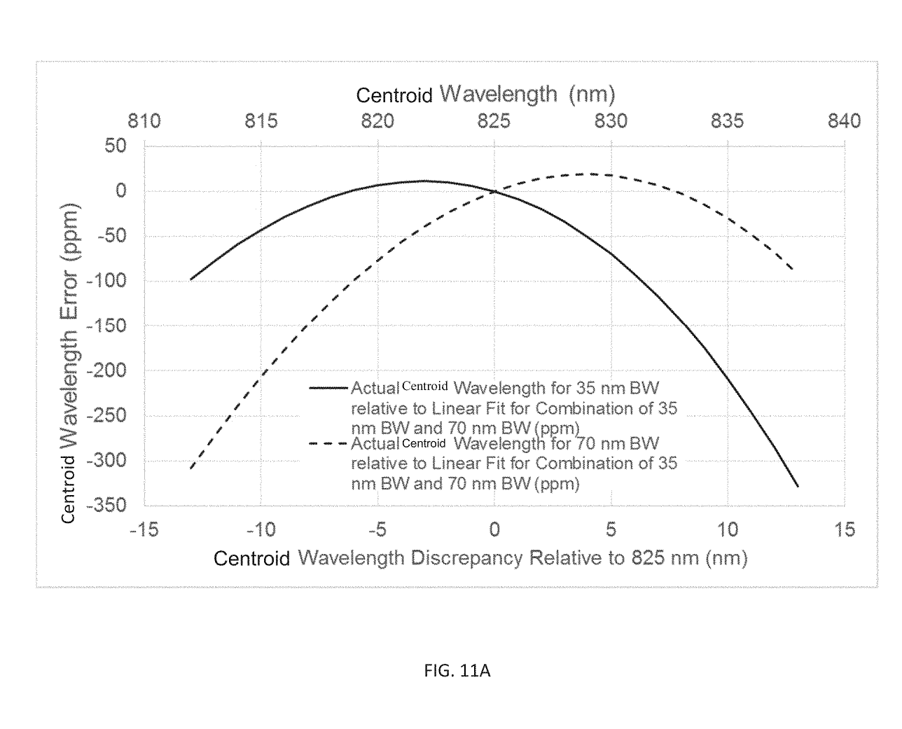

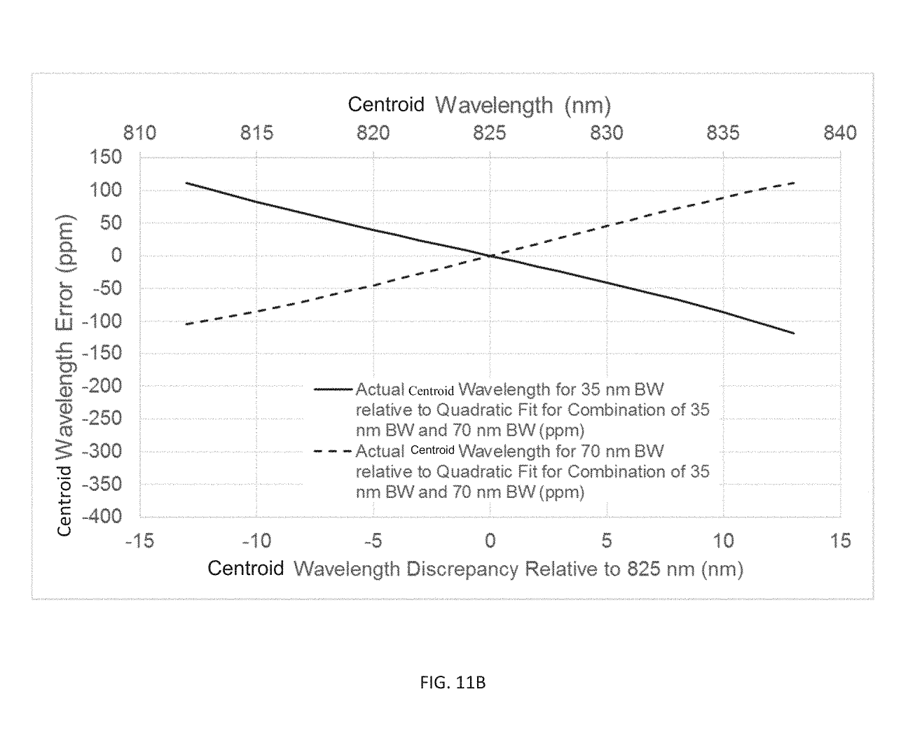

FIGS. 11A and 11B show plots of the centroid wavelength error of the centroid wavelength monitor signal vs. centroid wavelength discrepancy corresponding to the difference between the plots and fits shown in FIG. 10. The centroid wavelength error shown in FIG. 11A corresponds to the difference between the plots and the linear fit shown in FIG. 10, corresponding to centroid wavelength monitoring circuit 3′ that does not include a nonlinearity cancellation member but nevertheless is optimized with respect to a range of bandwidth, also known as FWHM. The wavelength error shown in FIG. 9B corresponds to the difference between the plots and the quadratic fit shown in FIG. 10, corresponding to centroid wavelength monitoring circuit 3″ that includes a nonlinearity cancellation member configured for quadratic cancellation, and further is optimized with respect to a range of bandwidth, also known as FWHM, thereby showing the benefit of optimization with respect to a range of spectral characteristics. The centroid wavelength error shown in FIG. 11A is as much as about 325 ppm in magnitude at the extremes of the centroid wavelength discrepancy range. In comparison, the centroid wavelength error shown in FIG. 11B is only as much as about 100 ppm in magnitude at the extremes of the centroid wavelength discrepancy range, thereby showing the benefit of both nonlinearity cancellation and optimization with respect to a range of spectral characteristics.

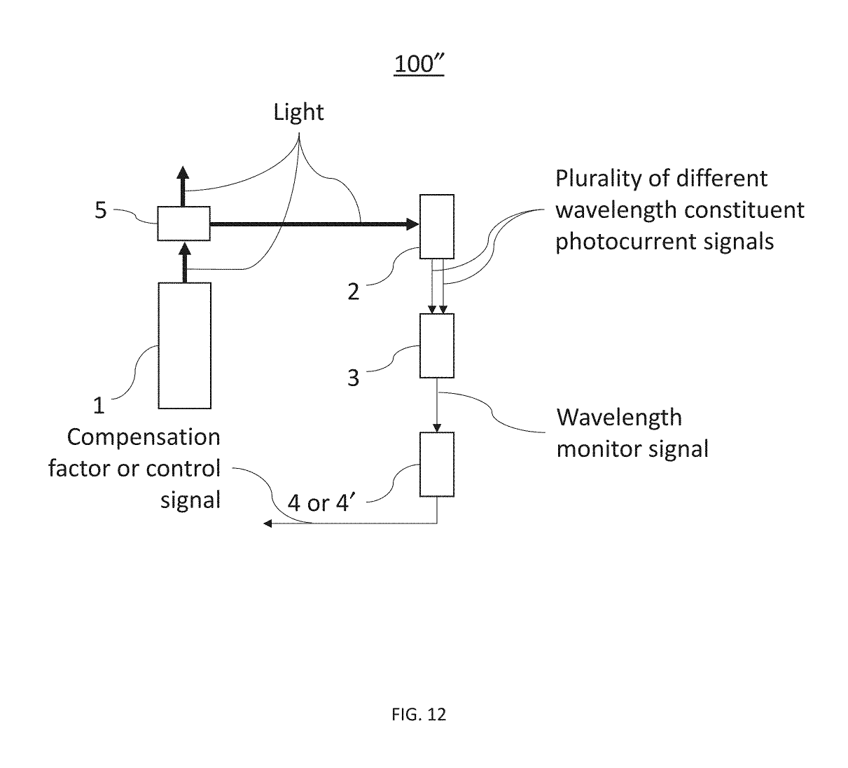

FIG. 12 is a schematic diagram of an embodiment of wavelength-corrective light source apparatuses 100 or 100′ of FIGS. 1A and 1B, shown as 100″, that further comprises pick-off member 5 for diverting a fraction of the light to wavelength-sensitive photodetector 2. Pick-off member may include at least one of a beamsplitter, a mirror, a fiber optic coupler, and an integrated waveguide coupler.

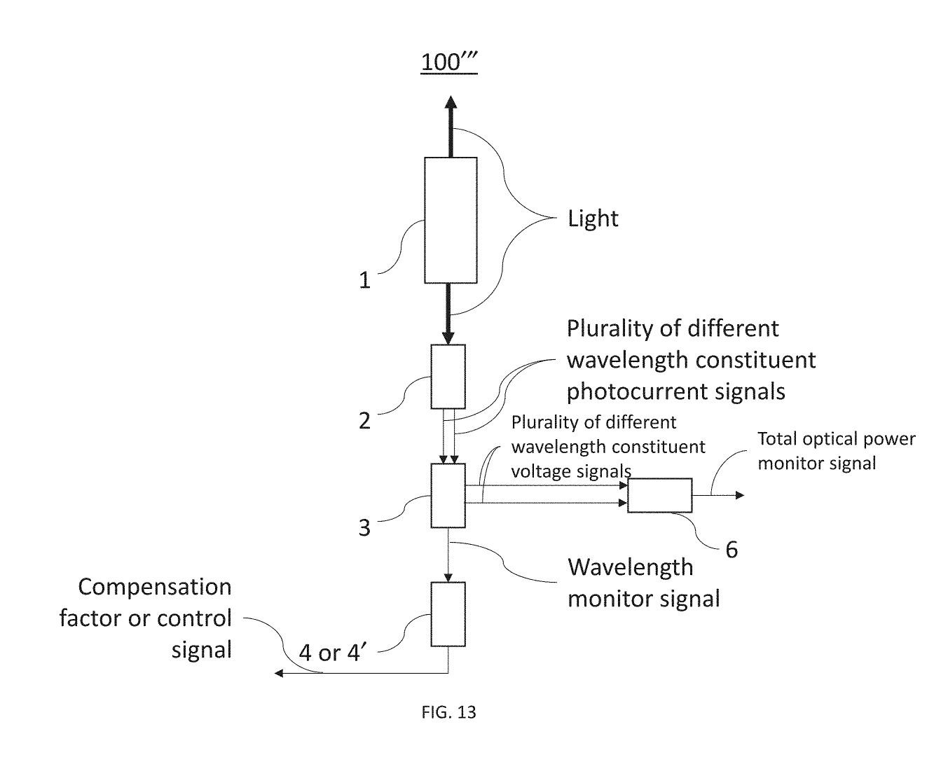

FIG. 13 is a schematic diagram of an embodiment of wavelength-corrective light source apparatuses 100 or 100′ of FIGS. 1A and 1B, shown as 100′″, that is further configured to monitor the total optical power incident upon wavelength-sensitive photodetector 2. Apparatus 100′″ further comprises optical power monitor circuit 6 that is configured to receive the plurality of wavelength constituent voltage signals and to deliver a total optical power monitor signal. Optical power monitor circuit 6 may comprise a summing amplifier.

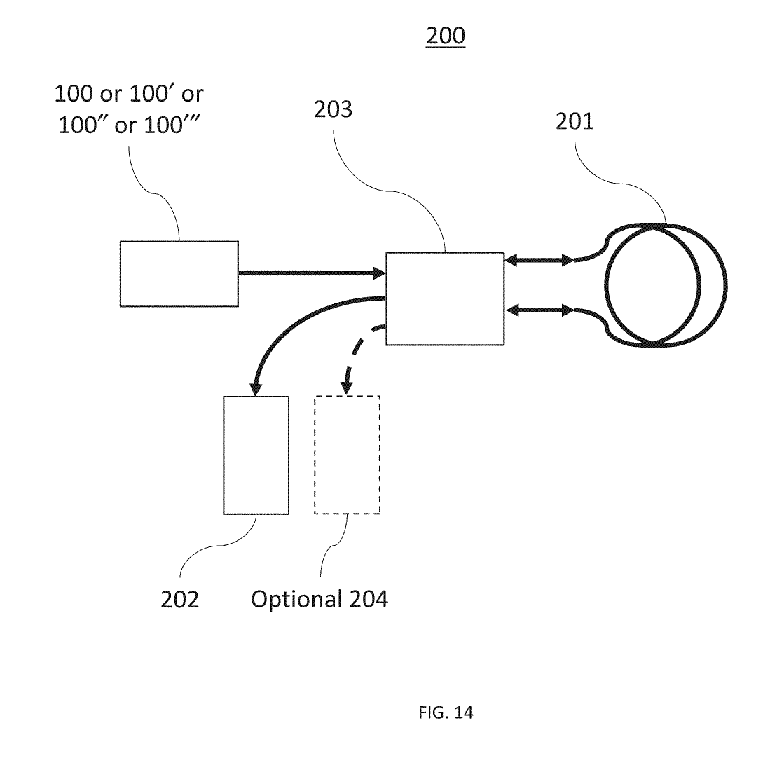

FIG. 14 is a schematic diagram of fiber-optic gyroscope (FOG) 200 that comprises wavelength-corrective light source apparatus 100, 100′, 100″, or 100′″. FOG 200 also comprises coil of optical fiber 201, rate photodetector 202, and phase modulator coupler optical circuit 203 configured to phase modulate the light from apparatus 100, 100′, 100″, or 100′″ and couple the light from the apparatus into coil of optical fiber 201 and further into rate detector 202. FOG 200 may further include an optional RIN detector 204.

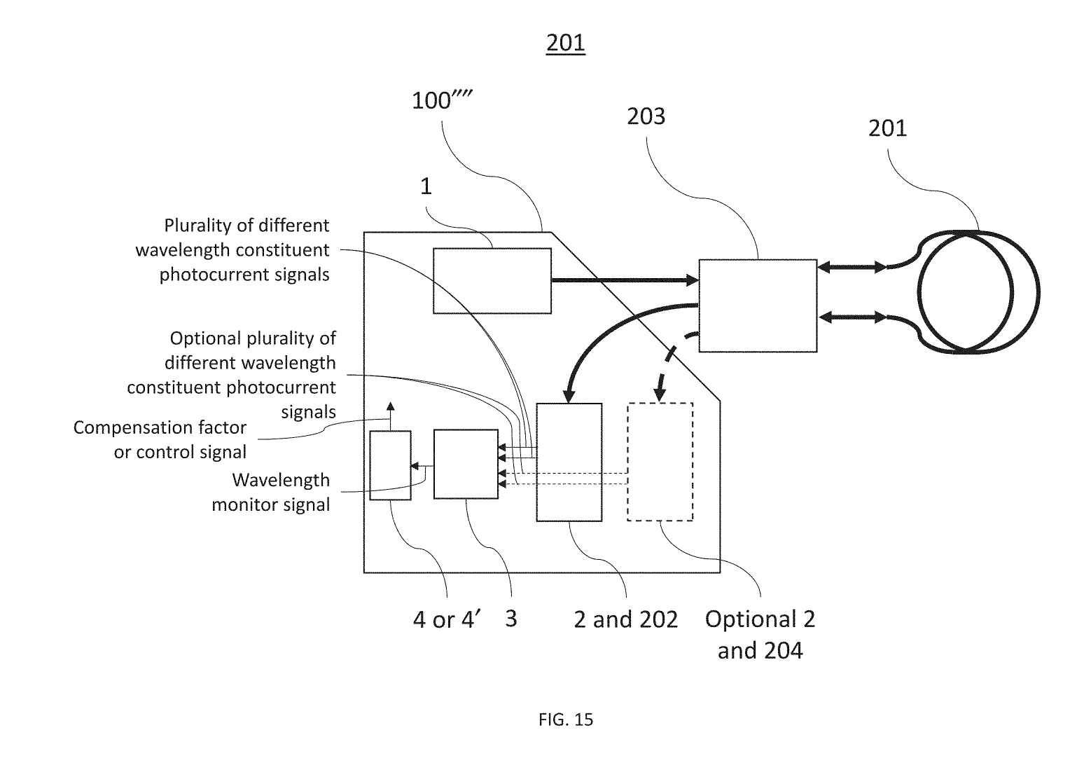

FIG. 15 is a schematic diagram of fiber-optic gyroscope (FOG) 201 that comprises wavelength-corrective light source apparatus 100″″ whereby at least one of rate photodetector 202 and optional RIN photodetector 204 comprise wavelength-sensitive photodetector 2.

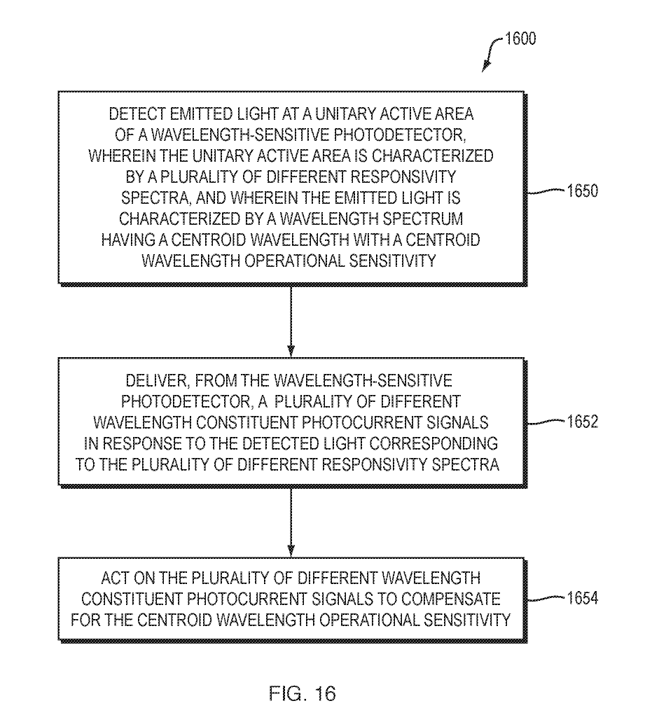

FIG. 16 is a flow diagram illustrating an embodiment procedure 1600 for correcting a light source centroid wavelength. At 1650, emitted light is detected at a unitary active area of a wavelength-sensitive photodetector. The unitary active area is characterized by a plurality of different responsivity spectra, and the emitted light is characterized by a wavelength spectrum having a centroid wavelength with a centroid wavelength operational sensitivity. FIGS. 3 and 4, for example, include illustrations of wavelength-sensitive photodetectors 2′ and 2″ having unitary active areas 20′ and 20″, respectively, for example. At 1652, a plurality of different wavelength constituent photocurrent signals are delivered from the wavelength-sensitive photodetector in response to the detected light, the photocurrent signals corresponding to respective responsivity spectra of the plurality of different responsivity spectra. A plurality of different wavelength constituent photocurrent signals are illustrated in FIG. 5, for example, and corresponding, respective responsivity spectra are illustrated in FIG. 6, for example.

Further in FIG. 16, at 1654, the plurality of different wavelength constituent photocurrent signals are acted upon to compensate for the centroid wavelength operational sensitivity. In various embodiments, acting upon the photocurrent signals to compensate for centroid wavelength operational sensitivity may include using the correction circuit 50 to produce the compensation factor described in connection with FIG. 1A or using the correction circuit 50′ to produce the control signal described in connection with FIG. 1B, for example. In addition to compensation, other embodiments may include cancelling a nonlinear dependence of a voltage difference signal used for compensation with respect to the wavelength spectrum of the light and delivering a related wavelength monitor signal, as described in connection with FIG. 7B, for example. It should be understood that other embodiment procedures may further optionally include any of the other features described herein in relation to other embodiments.

The invention has been described in detail with particular reference to certain preferred embodiments thereof, but it will be understood that variations and modifications can be effected within the scope of the invention as described above by a person of ordinary skill in the art without departing from the scope of the invention.

While this invention has been particularly shown and described with references to example embodiments thereof, it will be understood by those skilled in the art that various changes in form and details may be made therein without departing from the scope of the invention encompassed by the appended claims.

The teachings of all patents, published applications and references cited herein are incorporated by reference in their entirety.

What is claimed is:

1. A wavelength-corrective light source apparatus comprising:
a light source configured to emit light characterized by a wavelength spectrum having a centroid wavelength with a centroid wavelength operational sensitivity;
a wavelength-sensitive photodetector having a unitary active area characterized by a plurality of different responsivity spectra, the wavelength-sensitive photodetector configured to detect the light and to deliver a plurality of different wavelength constituent photocurrent signals in response to the detected light corresponding to the plurality of different responsivity spectra; and
a centroid wavelength correction circuit configured to receive and act on the plurality of different wavelength constituent photocurrent signals to compensate for the centroid wavelength operational sensitivity.

2. The apparatus of claim 1, wherein the plurality of different wavelength constituent photocurrent signals has a nonlinearity with respect to the centroid wavelength, and wherein the centroid wavelength correction circuit includes a nonlinearity cancellation member configured to cancel the nonlinearity.

3. The apparatus of claim 1, wherein the centroid wavelength correction circuit includes a centroid wavelength monitoring circuit configured to receive the plurality of different wavelength constituent photocurrent signals, the centroid wavelength monitoring circuit comprising a plurality of transimpedance amplifiers such that each transimpedance amplifier of the plurality of transimpedance amplifiers is configured to convert a respective one of the different wavelength constituent photocurrent signals of the plurality of different wavelength constituent photocurrent signals to a respective wavelength constituent voltage signal of a plurality of different wavelength constituent voltage signals.

4. The apparatus of claim 3, wherein at least one of the plurality of transimpedance amplifiers is a logarithmic transimpedance amplifier.

5. The apparatus of claim 3, wherein the centroid wavelength monitoring circuit is further configured to operate on the plurality of different wavelength constituent voltage signals to deliver at least one voltage difference signal for use as a centroid wavelength monitor signal, the centroid wavelength correction circuit further comprising a centroid wavelength correction member configured to receive the at least one centroid wavelength monitor signal and to compensate for the operational sensitivity by delivering a compensation factor, based on the centroid wavelength monitor signal, for compensating for a discrepancy between the centroid wavelength and a predetermined reference wavelength.

6. The apparatus of claim 1, wherein the light source is a broadband light source including at least one of a superluminescent diode (SLD), a rare-earth-doped superluminescent source (REDSLS), and a light emitting diode (LED), and wherein the wavelength spectrum has a FWHM bandwidth of about 5 nm or greater.

7. The apparatus of claim 1, wherein the light source is a narrowband light source including at least one of a laser, a laser diode (LD), and a tunable laser diode (TLD), and wherein the wavelength spectrum has a full width at half maximum (FWHM) bandwidth less than about 5 nm.

8. The apparatus of claim 1, wherein the centroid wavelength operational sensitivity includes at least one of a centroid wavelength thermal sensitivity and a centroid wavelength drive current sensitivity.

9. The apparatus of claim 1, wherein the wavelength-sensitive photodetector includes at least one of (a) a photodetector comprised of at least two PN junctions formed at different depths from a light-exposable surface of a semiconductor substrate, and (b) a photodetector comprised of at least two photodiodes that are arranged in a cascade relationship.

10. The apparatus of claim 1, wherein the centroid wavelength correction circuit is further configured to measure or adjust at least one of a bandwidth, asymmetry, and shape of the wavelength spectrum.

11. The apparatus of claim 1, wherein the centroid wavelength correction circuit includes at least one of a microprocessor, an application-specific integrated circuit (ASIC), and a field-programmable gate array (FPGA).

12. The apparatus of claim 1, further comprising an optical power monitor circuit configured deliver a total optical power monitor signal derived from the plurality of different wavelength constituent photocurrent signals, the total optical power monitor signal indicative of a total optical power incident upon wavelength-sensitive photodetector.

13. A fiber-optic gyroscope (FOG) including the wavelength-corrective light source apparatus of claim 1.

14. The FOG of claim 13, further comprising at least one of a coil of optical fiber, a rate detector, and a phase modulator coupler optical circuit configured to phase modulate the light from the light source and to couple the light from the light source into the coil of optical fiber and further into the at least one rate photodetector.

15. The FOG of claim 13, further comprising at least one relative intensity noise (RIN) photodetector.

16. A wavelength-corrective fiber-optic gyroscope (FOG) apparatus comprising:
a light source configured to emit light characterized by a wavelength spectrum having a centroid wavelength with a centroid wavelength operational sensitivity;
a wavelength-sensitive photodetector having a unitary active area characterized by a plurality of different responsivity spectra, the wavelength-sensitive photodetector configured to detect the light and to deliver a plurality of different wavelength constituent photocurrent signals in response to the detected light corresponding to the plurality of different responsivity spectra;
a centroid wavelength correction circuit configured to receive and act on the plurality of different wavelength constituent photocurrent signals to correct for the operational sensitivity; and
a light coupler configured to couple the light from the light source into a coil of optical fiber.

17. The apparatus of claim 16, wherein the centroid wavelength correction circuit is further configured to correct for the operational sensitivity by compensating for the operational sensitivity.

18. The apparatus of claim 16, wherein the centroid wavelength correction circuit is further configured to correct for the operational sensitivity by controlling the centroid wavelength.

19. The apparatus of claim 16, wherein the plurality of different wavelength constituent photocurrent signals has a nonlinearity with respect to the centroid wavelength, and wherein the wavelength correction circuit includes a nonlinearity cancellation member configured to cancel the nonlinearity.

20. A method of correcting a light source wavelength, the method comprising:
detecting emitted light at a unitary active area of a wavelength-sensitive photodetector, the unitary active area characterized by a plurality of different responsivity spectra, and the emitted light characterized by a wavelength spectrum having a centroid wavelength with a centroid wavelength operational sensitivity;
delivering, from the wavelength-sensitive photodetector, a plurality of different wavelength constituent photocurrent signals in response to the detected light corresponding to the plurality of different responsivity spectra; and
acting on the plurality of different wavelength constituent photocurrent signals to compensate for the centroid wavelength operational sensitivity.
